(19) United States
(12) Patent Application Publication
(10) Pub. No.: US 2020/0124233 A1
(43) Pub. Date: Apr. 23, 2020

(54) STATION AND METHOD FOR FILLING PRESSURIZED GAS TANKS

(71) Applicant: L'Air Liquide, Societe Anonyme pour l'Etude et l'Exploitation des Procedes Georges Claude, Paris (FR)

(72) Inventors: Jean-Jacques CHOLLAT, Voiron (FR); Thibaut FRANCOIS, Fontanil Cornillon (FR); Nicolas JANNIN, Saint Egreves (FR); Thierry OTT, Brunoy (FR)

(73) Assignee: L'Air Liquide, Societe Anonyme pour l'Etude et l'Exploitation des Procedes Georges Claude, Paris (FR)

(21) Appl. No.: 16/625,674

(22) PCT Filed: Jun. 20, 2018
(86) PCT No.: PCT/FR2018/051477

§ 371 Date: Dec. 20, 2019

(30) Foreign Application Priority Data
Jun. 27, 2017 (FR) FR 1755891

(51) Int. Cl. F17C 5/00; F17C 5/06

(52) U.S. Cl. CPC F17C 5/007; F17C 5/06; F17C 2205/0326; F17C 2221/012; F17C 2223/0123; F17C 2223/0161; F17C 2270/0139; F17C 2227/0128; F17C 2227/0341; F17C 2227/0365; F17C 2227/043; F17C 2260/046; F17C 2265/065; F17C 2225/0123

(57) ABSTRACT

A station for filling pressurized gas tanks comprising a filling circuit having an upstream end connected to at least one source of gas and a downstream end, the filling circuit comprising a unit for compressing gas coming from the source, the filling station comprising a device for cooling the compressed gas comprising a heat exchanger situated in the filling circuit configured to provide heat exchange between the pressurized gas and a cooling fluid, the cooling device comprising a reserve of cryogenic liquid constituting the cooling fluid and a cooling circuit connecting the reserve of cryogenic liquid to the heat exchanger in order to transfer heat from the pressurized gas to the cryogenic liquid, the cooling circuit further comprising a gas sampling line connecting a volume containing the vaporized gas from the reserve to the heat exchanger.

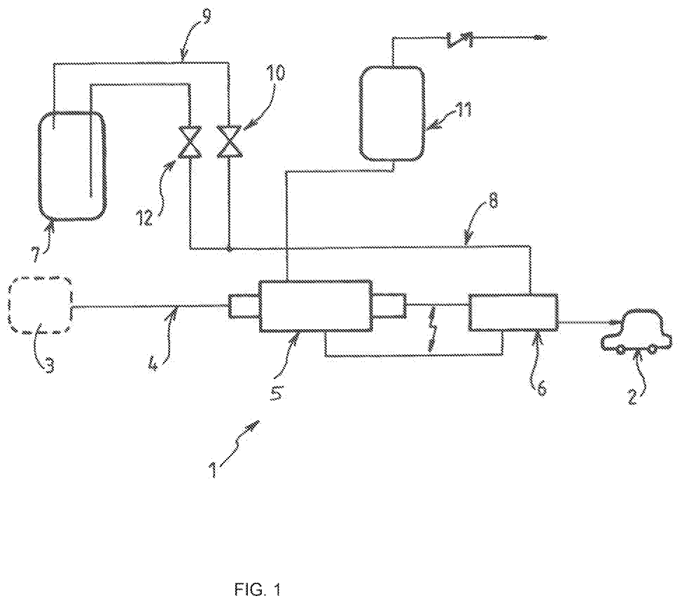

### CROSS-REFERENCE TO RELATED APPLICATIONS

This application is a § 371 of International PCT Application PCT/FR2018/051477, filed Jun. 20, 2018, which claims § 119(a) foreign priority to French patent application FR 1755891, filed Jun. 27, 2017.

### BACKGROUND

### Field of the Invention

The invention relates to an installation and a method for filling a tank or tanks.

The invention relates more particularly to a station for filling pressurized gas tanks, in particular hydrogen tanks of vehicles, comprising a filling circuit having an upstream end connected to at least one gas source and a downstream end intended to be connected to at least one tank to be filled, the filling circuit comprising a unit for compressing the gas from the source, the filling station comprising a device for cooling the compressed gas comprising a heat exchanger located in the filling circuit configured to ensure a heat exchange between the pressurized gas and a cooling fluid, the cooling device comprising a store of cryogenic liquid constituting the cooling fluid and a cooling circuit connecting the store of cryogenic liquid to the heat exchanger for transferring frigories from the cryogenic liquid to the pressurized gas.

### Related Art

It is known practice to carry out a cooling operation during the rapid filling of pressurized hydrogen gas tanks.

This generally requires an expensive cooling unit. The installation of a filling station in an urban environment close to homes requires, moreover, reducing the noise from the station.

Known solutions use a liquid nitrogen cooling system. Other solutions use an autonomous cooling unit since the management of the liquid nitrogen and of the corresponding heat exchanger could be insufficiently optimized.

### SUMMARY OF THE INVENTION

It is an object of the present invention to alleviate all or some of the abovementioned disadvantages of the prior art.

To this end, the station according to the invention, moreover in accordance with the generic definition given thereto in the preamble above, is essentially characterized in that the cooling circuit further comprises a gas withdrawal line connecting a volume containing the vaporized gas from the store to the heat exchanger, for transferring frigories from the vaporized cryogenic cooling fluid to the heat exchanger.

Moreover, embodiments of the invention may comprise one or more of the following features:
the withdrawal line comprises a valve, in particular a pilot valve,
the withdrawal line has an end connected to the cooling circuit,
the cooling circuit comprises, downstream of the heat exchanger, a portion connecting an outlet of the heat exchanger to the compression unit, for transferring frigories from the cryogenic fluid to the compression unit and in particular by heat exchange of the cooling fluid with one or more compression chambers of the compression unit,
the cooling circuit comprises, downstream of the outlet of the heat exchanger, a jacket ensuring heat exchange with the filling circuit upstream and/or downstream of the exchanger,
the cooling circuit comprises, downstream of the compression unit, a portion connecting an outlet of the compression unit to a tank for recovering vaporized cryogenic fluid,
the cryogenic cooling fluid comprises nitrogen.

The invention also relates to a method for filling a tank with a pressurized gas, in particular filling the tank of a vehicle with hydrogen, by means of a filling station comprising a filling circuit provided with an upstream end connected to at least one gas source and a downstream end intended to be connected to at least one tank to be filled, the filling circuit comprising a unit for compressing the gas from the source, the filling station comprising a device for cooling the compressed gas comprising a heat exchanger located in the filling circuit configured to allow a heat exchange between the pressurized gas and a liquefied cryogenic cooling fluid of a liquefied cryogenic fluid store, the method comprising a step of transferring frigories between vaporized cryogenic fluid in the store and the heat exchanger.

According to other specific features:
the step of transferring frigories between the vaporized cryogenic fluid in the store and the heat exchanger is carried out at a time distinct from the heat exchange between the pressurized gas and the liquefied cryogenic cooling fluid,
the step of transferring frigories between vaporized cryogenic fluid in the store and the heat exchanger is carried out between two steps of transferring fluid from the gas source to the tank to be filled, that is to say for keeping the heat exchanger cold before filling or between two filling operations,
the heat exchanger is maintained at a temperature of between −30° C. and −50° C. by the step of transferring frigories between vaporized cryogenic fluid and the heat exchanger,
the method comprises a step of transferring frigories between vaporized cryogenic fluid in the store and at least one of the following elements of the station: an electrical cabinet, a hydraulic power source, a fluid transfer line.

The invention may also relate to any alternative device or method comprising any combination of the features above or below.

### BRIEF DESCRIPTION OF THE FIGURES

Other specific features and advantages will become apparent from reading the following description, given with reference to the single FIGURE which represents one possible example of the structure and operation of the invention.

### DETAILED DESCRIPTION OF THE INVENTION

The filling station 1 shown in the FIGURE conventionally comprises a filling circuit 4 having an upstream end connected to at least one gas source 3 and at least one downstream end intended to be connected to at least one tank 2 to be filled. The terms “upstream” and “downstream” refer to the direction of flow of the fluid.

The gas source 3 may comprise at least one or more of: one or more pressurized gas storages (in particular storages connected in parallel to allow cascade pressure equilibration phases), a source of liquefied gas, a vaporizer, an electrolyzer, etc.

The filling circuit 4 comprises a unit 5 for compressing the gas from the source 3, for example at least one compressor.

Downstream of the compressor 5, the station 1 also comprises a device for cooling the compressed gas comprising a heat exchanger 6 located in the filling circuit 4.

Conventionally, the exchanger 6 is configured to ensure indirect heat exchange between the pressurized gas and a cooling fluid, in particular liquid nitrogen, between −196° C. and −200° C. For this purpose, the cooling device comprises a store 7 of cryogenic fluid (liquid nitrogen or other as appropriate) and a cooling circuit 8 connecting the cryogenic fluid store 7 to the heat exchanger 6 for transferring cryogenic fluid frigories to the pressurized gas. That is to say that the cooling circuit comprises a line for withdrawing liquid from the store 7 which is conveyed into the heat exchanger 6 to cool the gas transferred to the tank 2. For example, the gas is cooled to a fixed or variable target temperature depending on the filling conditions (for example between −40° C. and −20° C.).

Preferably, the cooling exchanger 6 has or is associated with a mass of material (metal or other) forming a cold store (a frigory store) to ensure sufficient thermal inertia.

According to one advantageous specific feature, the cooling circuit 8 comprises a gas withdrawal line 9 connecting (preferably via a valve 10) a volume containing the vaporized gas from the store 7 to the heat exchanger 6, for transferring frigories from the vaporized cryogenic fluid to the heat exchanger 6. That is to say that the gas withdrawal line 9 is distinct from the liquid withdrawal line.

The liquid withdrawal line 8 can be connected to the lower part of the tank 7, while the gas withdrawal lines can be connected to the upper part of the tank 7.

During hydrogen filling, it may be necessary to bring a large number of frigories into the exchanger 6 (via the circulation of liquid in the cooling circuit 8).

In order to optimize the performance, it may be necessary to keep the exchanger 6 cold, especially outside the filling phases. The maintaining of the cold conditions may thus be produced via the exploitation of this vaporized gas.

The exchanger 6 may be maintained for example between −30° C. and −50° C. This makes it possible to optimize the nitrogen consumption and to avoid unnecessary losses while decreasing the cooling time of the station 1.

For example, as shown, the upstream end of the gas withdrawal line 9 is connected to the upper portion of the tank 7 (which houses the gas phase). Of course, the gas withdrawal line 9 could be connected to a separate tank that receives vaporized fluid (“boil-off gas”).

The withdrawal line 9 preferably comprises a valve 10, for example a pilot valve.

The downstream end of the withdrawal line 9 is for example connected to the cooling circuit 8 (so that part of these two circuits may be common).

As shown, the vaporized gas that has been used for keeping the exchanger 6 cold can be further exploited in the compressor 5 or elsewhere in the station 1.

Thus, the cooling circuit 8 may comprise, downstream of the heat exchanger 6, a portion connecting an outlet of the heat exchanger 6 to the compressor 5, for transferring frigories from the fluid to the latter and in particular by heat exchange with one or more compression chambers of the compression unit 5.

Similarly, downstream of the exchanger 6, a transfer of frigories can be envisioned between the vaporized cryogenic fluid and at least one of the following elements of the station 1: an electrical cabinet, a hydraulic power source, a fluid transfer line or any other appropriate unit. This is indicated schematically by a double arrow between the circuits 8 and 4 in the FIGURE.

Thus, either the liquid nitrogen or the vaporized nitrogen which has been used to transfer frigories into the heat exchanger 6 can furthermore be exploited to cool one or more additional units of the station 1.

For example, the cooling circuit 8 comprises, downstream of the outlet of the heat exchanger 6, a jacket ensuring heat exchange with the filling circuit 4 upstream and/or downstream of the exchanger 6. For example, the jacket separates the cooling circuit fluid and the gas circuit or an element to be cooled, and the jacket is configured to allow heat exchange between these two entities.

Finally, this stored heated nitrogen gas 11 can be used for the inerting of components such as the chamber(s) in the inter-stage of the compressor(s) 5 and also for controlling the valve(s) for regulating the station 1.

The surplus may be discharged in a vent.

While the invention has been described in conjunction with specific embodiments thereof, it is evident that many alternatives; modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. A station for filling a tank with pressurized gas, comprising a filling circuit and a device for cooling compressed gas, wherein:
the filling circuit has an upstream end connected to at least one gas source, a downstream end intended to be connected to at least one tank to be filled, and a unit for compressing gas from the at least one gas source to provide the pressurized gas for filling the tank;
the device for cooling the compressed gas comprising a heat exchanger located in the filling circuit that is configured to exchange heat between the pressurized gas and a cooling fluid, a store of cryogenic liquid constituting the cooling fluid, and a cooling circuit connecting the store of cryogenic liquid to the heat exchanger, via a line for withdrawing liquid from the store which transfers liquid from the store to the heat exchanger, such that frigories are transferred from the cryogenic liquid to the pressurized gas, wherein the cooling circuit also comprises a gas withdrawal line connecting a volume containing the vaporized gas of the store to the heat exchanger, such that frigories are transferred from the vaporized cryogenic cooling fluid to the heat exchanger.

14. The station of claim 13, wherein the withdrawal line comprises a valve, in particular a pilot valve.

15. The station of claim 13, wherein the withdrawal line has an end connected to the cooling circuit.

16. The station of claim 13, wherein the cooling circuit comprises, downstream of the heat exchanger, a portion connecting an outlet of the heat exchanger to the compression unit, for transferring frigories from the cryogenic fluid to the compression unit and in particular by heat exchange of the cooling fluid with one or more compression chambers of the compression unit.

17. The station of claim 16, wherein the cooling circuit comprises, downstream of the outlet of the heat exchanger, a jacket ensuring a heat exchange with the filling circuit upstream and/or downstream of the exchanger.

18. The station of claim 16, wherein the cooling circuit comprises, downstream of the compression unit, a portion connecting an outlet of the compression unit to a tank for recovering vaporized cryogenic fluid.

19. The station of claim 13, wherein the cryogenic cooling fluid comprises nitrogen.

20. A method for filling a tank with a pressurized gas, by means of a filling station comprising a filling circuit provided with an upstream end connected to at least one gas source and a downstream end intended to be connected to at least one tank to be filled, the filling circuit comprising a unit for compressing the gas from the source, the filling station comprising a device for cooling the compressed gas comprising a heat exchanger located in the filling circuit configured to allow a heat exchange between the pressurized gas and a liquefied cryogenic cooling fluid of a liquefied cryogenic fluid store via a line for withdrawing liquid from the store, which is fed to the heat exchanger, the method comprising a step of transferring frigories between vaporized cryogenic fluid in the store and the heat exchanger.

21. The method of claim 20, wherein the step of transferring frigories between the vaporized cryogenic fluid in the store and the heat exchanger is carried out at a time distinct from the heat exchange between the pressurized gas and the liquefied cryogenic cooling fluid.

22. The method of claim 20, wherein the step of transferring frigories between vaporized cryogenic fluid in the store and the heat exchanger is carried out between two steps of transferring fluid from the gas source to the tank to be filled, that is to say to keep the heat exchanger cold before filling or between two filling operations.

23. The method of claim 22, wherein the heat exchanger is maintained at a temperature of between −30° C. and −50° C. by the step of transferring frigories between vaporized cryogenic fluid and the heat exchanger.

24. The method of claim 20, wherein it comprises a step of transferring frigories between vaporized cryogenic fluid in the store and at least one of the following elements of the station: an electrical cabinet, a hydraulic power source, a fluid transfer line.

25. The method of claim 20, wherein the pressurized gas is hydrogen and the tank is a tank of a vehicle.
